(19) United States
(12) Patent Application Publication
(10) Pub. No.: US 2026/0219794 A1
(43) Pub. Date: Jul. 30, 2026

(54) INITIALIZATION OF RAID ARRAY TO ENSURE CONFIGURATION INTEGRITY DURING COMPUTER SYSTEM STARTUP

(71) Applicant: Super Micro Computer, Inc., San Jose, CA (US)

(72) Inventor: Kelvin TSENG, San Jose, CA (US)

(21) Appl. No.: 19/041,150

(22) Filed: Jan. 30, 2025

(51) Int. Cl. G06F 3/06

(52) U.S. Cl. CPC G06F 3/0632; G06F 3/0619; G06F 3/0689

(57) ABSTRACT

Disclosed are a computer system and a method for initializing a Redundant Array of Independent Disks (RAID) array during startup of the computer system. The connection between a RAID controller and the RAID array is disabled during startup of the computer system. The presence of member drives of the RAID array and the readiness of the member drives to operate are checked while the RAID controller-to-RAID array connection is disabled. The RAID controller-to-RAID array connection is enabled when the member drives are ready to operate. The integrity of the configuration of the RAID array is thereafter verified.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure is directed generally to computer systems, and more particularly to data storage systems.

### BACKGROUND

Redundant Array of Independent Disks (RAID) is a widely used data storage technology that combines multiple physical drives into a single logical unit, offering enhanced performance, reliability, and fault tolerance. Various RAID levels (e.g., RAID 0, 1, 5, 6) balance these attributes differently, with configurations such as RAID 5 and RAID 6 providing redundancy through parity, enabling data recovery in the event of individual drive failures.

A degraded RAID array occurs when a drive in the array fails or becomes unavailable, causing the array to lose redundancy and operate in a compromised state. In this condition, the RAID array relies on parity data or mirroring to reconstruct missing information, significantly increasing the workload on the remaining drives and the RAID controller. Operating a degraded RAID array increases the risk of data loss, as an additional failure during this state can lead to irrecoverable data. Moreover, performance degradation may impact system responsiveness, delaying access to critical data.

### BRIEF SUMMARY

In one embodiment, a method of initializing a Redundant Array of Independent Disks (RAID) array during startup of a computer system includes disabling a connection between a RAID controller and a drive expander, wherein the RAID array is connected to the RAID controller through the drive expander. Presence of member drives of the RAID array and readiness of the member drives to operate are checked. The connection between the RAID controller and the drive expander is enabled when the member drives are ready to operate. The integrity of the configuration of the RAID array is thereafter verified.

In another embodiment, a computer system comprises a RAID controller, a RAID array, and a drive expander that connects the RAID controller to the RAID array. The drive expander comprises at least one processor that executes instructions to cause the drive expander to: disable a connection between the RAID controller and the drive expander during startup of the computer system; check for presence of member drives of the RAID array; check readiness of the member drives; and enable the connection between the RAID controller and the drive expander after checking readiness of the member drives.

In yet another embodiment, a method of initializing a RAID array during startup of a computer system includes disabling a connection between a RAID controller and a RAID array. While the connection between the RAID controller and the RAID array is disabled, presence of member drives of the RAID array and readiness of the member drives are checked. After checking the readiness of the member drives, the connection between the RAID controller and the RAID array is enabled. The integrity of the configuration of the RAID array is verified after the connection between the RAID controller and the RAID array is enabled.

These and other features of the present disclosure will be readily apparent to persons of ordinary skill in the art upon reading the entirety of this disclosure, which includes the accompanying drawings and claims.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 shows a block diagram of a computer system, in accordance with an embodiment of the present invention.

FIG. 2 shows a flow diagram of a method of initializing a RAID array during startup of a computer system, in accordance with an embodiment of the present invention.

FIG. 3 shows a pseudocode for initializing a RAID array during startup of a computer system, in accordance with an embodiment of the present invention.

### DETAILED DESCRIPTION

In the present disclosure, numerous specific details are provided, such as examples of systems, components, and methods, to provide a thorough understanding of embodiments of the invention. Persons of ordinary skill in the art will recognize, however, that the invention can be practiced without one or more of the specific details. In other instances, well-known details are not shown or described to avoid obscuring aspects of the invention.

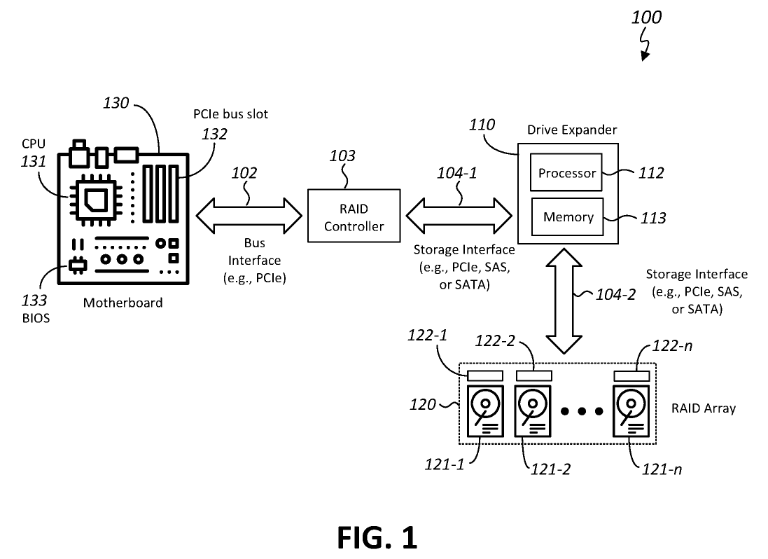

FIG. 1 shows a block diagram of a computer system 100, in accordance with an embodiment of the present invention. The computer system 100 may be a server computer system, such as those commercially-available from Super Micro Computer, Inc., for example. In one embodiment, the computer system 100 comprises one or more central processing units (CPUs) 131, a Redundant Array of Independent Disks (RAID) controller 103, a drive expander 110, and a RAID array 120.

A CPU 131 is a processor of a motherboard 130. The CPU 131 or other components of the motherboard 130 may communicate with input/output (I/O) devices by way of one or more bus interfaces 102. In one embodiment, the bus interface 102 is a Peripheral Component Interconnect Express (PCIe) interface. The motherboard 130 may include one or more PCIe bus slots 132, into which a card (e.g., printed circuit board (PCB)) that embodies the RAID controller 103 is plugged. This way, the CPU 131 or other components of the motherboard 130 may communicate with the RAID controller 103 over the bus interface 102 in accordance with the PCIe standard.

The RAID controller 103 and the RAID array 120 form a data storage system. The RAID array 120 comprises a plurality of member drives 121 (i.e., 121-1, 121-2, ..., 121-n). A drive 121 may be a hard disk drive, solid state drive, or other type of storage device used in a RAID array. The RAID controller 103 is configured to control the operations of the RAID array 120 in accordance with RAID conventions. The RAID controller 103 communicates with the RAID array 120 over a storage interface 104 (i.e., 104-1, 104-2). The storage interface 104 may be a PCIe interface, serial attached Small Computer System Interface (SAS) interface, or Serial Advanced Technology Attachment (SATA) interface, for example.

The drive expander 110 functions as a drive switch that increases the number of drives 121 that can be connected to and controlled by the RAID controller 103. The drive expander 110 may be implemented using an integrated circuit (IC) chip (e.g., from Broadcom Inc.) with internal or external processor 112 and memory 113. In one embodiment, the drive expander 110 is an IC chip that is mounted on a backplane that has backplane connectors 122 (i.e., 122-1, 122-2, ..., 122-n). In that configuration, each of the drives 121 is connected to the drive expander 110 by way of a corresponding backplane connector 122, and the RAID controller 103 may be connected to the drive expander 110 by way of a plurality of cables.

The motherboard 130 may include firmware 133 comprising instructions of a startup program, which is also referred to as a Basic Input/Output System (BIOS). When the computer system 100 starts up from a power down or restart, the startup program commences a boot process that includes the RAID controller 103 verifying the integrity of the configuration of the RAID array 120. The configuration integrity verification may include scanning the topology of the RAID array 120 to discover, identify, and verify all the member drives of the RAID array 120, their connections, and their roles within the RAID array 120.

Generally, the amount of time for a drive to be ready to operate depends on the type and capacity (i.e., storage size) of the drive. For example, a high-capacity hard disk drive may take up to 31 seconds to be ready. This poses a problem with fast system startup times, such as less than 20 seconds, because the drive, although normal (i.e., not broken), may not yet be ready to operate when the RAID controller 103 scans the topology of the RAID array 120. In that case, the RAID array 120 will be marked as degraded.

As a particular example, a RAID array may have 4 member drives that are configured as RAID 5. If one of the 4 member drives is not ready during the same topology scanning cycle, the RAID controller will fail to recognize the non-ready drive and, consequently, the RAID array will be marked as degraded even though the non-ready drive is operational but is simply taking some time to come up because of its large storage capacity.

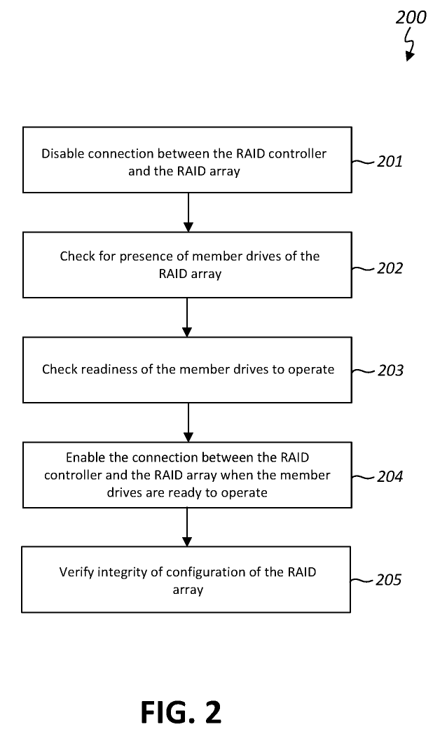

FIG. 2 shows a flow diagram of a method 200 of initializing the RAID array 120 during startup of the computer system 100, in accordance with an embodiment of the present invention. In one embodiment, steps 201-204 of the method 200 are performed by the drive expander 110, and step 205 is performed by the RAID controller 103. The method 200 may be implemented as instructions (i.e., program code) stored in memory for execution by at least one processor.

In step 201, the method 200 includes disabling the connection between the RAID controller 103 and the RAID array 120 when the computer system 100 is started up. This prevents the RAID controller 103 from seeing the RAID array 120 and thereby prematurely scanning the topology of the RAID array 120. In one embodiment, the connection between the RAID controller 103 and the RAID array 120 is disabled by disabling the serializer/deserializer (SerDes) physical layer (PHY) connection between the RAID controller 103 and the drive expander 110.

In step 202, after the connection between the RAID controller 103 and the RAID array 120 is disabled, the method 200 includes checking for presence of the drives 121. In one embodiment, the presence of a drive 121 is detected by checking a state of a presence pin on a corresponding connector 122. In one embodiment, a connector 122 is an SFF-8639 connector, and the presence pin is pin P10 of the SFF-8639 connector. When a drive 121 is connected to the SFF-8639 connector, the state of the presence pin changes, thereby detecting presence of the drive 121 in the RAID array 120.

In step 203, the method 200 includes checking the readiness of the drives 121 that have been detected to be present. The readiness of a drive 121 may be checked by reading back a status port register of the drive 121, for example.

In step 204, the method 200 includes enabling the connection between the RAID controller 103 and the RAID array 120 when the drives 121 that have been detected to be present are ready to operate. This allows the RAID controller 103 to recognize the drives 121 and initiate the configuration integrity verification. In one embodiment, the connection between the RAID controller 103 and RAID array 120 is enabled by enabling the SerDes PHY connection between the RAID controller 103 and the drive expander 110.

In step 205, after the connection between the RAID controller 103 and the RAID array 120 has been enabled, the method 200 includes the RAID controller 103 verifying the integrity of the configuration of the RAID array 120. The configuration integrity verification may include the RAID controller 103 scanning the topology of the RAID array 120. As can be appreciated, the method 200 ensures that member drives of a RAID array are ready for operation before they are presented to a RAID controller, thereby advantageously avoiding problems associated with premature RAID array configuration integrity verification.

The method 200 may include provisions for handling malfunctioning drives 121. For example, steps 202 and 203 may be performed within a predetermined, configurable readiness period. The readiness period may be set to accommodate the time it takes the drives 121 to be ready. The connection between the RAID controller 103 and the RAID array 120 is enabled at expiration of the readiness period. At this time, any missing or nonoperational drives 121 will be detected by the RAID controller 103. The RAID controller 103 or other component may then mark the RAID array 120 as degraded and perform corresponding mitigation.

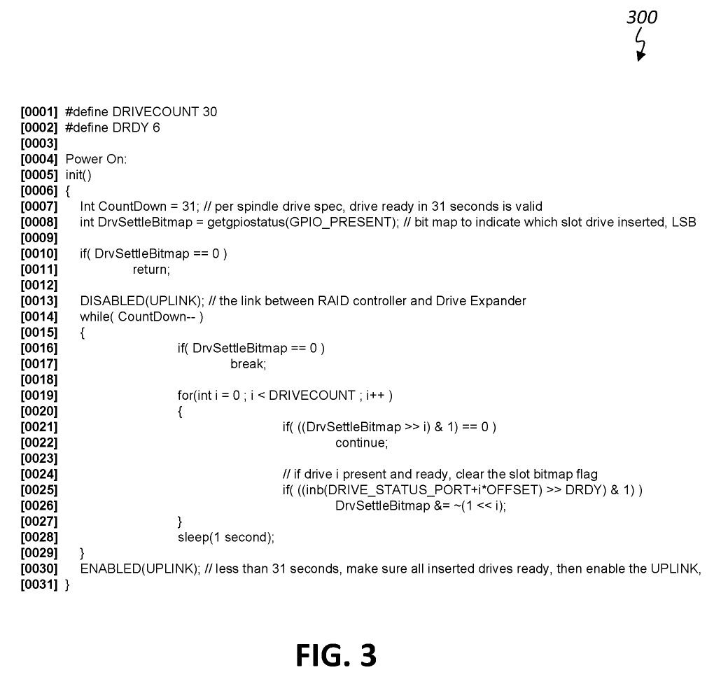

FIG. 3 shows a pseudocode 300 for initializing the RAID array 120 during startup of the computer system 100, in accordance with an embodiment of the present invention. In one embodiment, the pseudocode 300 is performed by the drive expander 110. In that embodiment, instructions that implement the pseudocode 300 may be stored in the memory 113 for execution by at least one processor 112 to cause the drive expander 110 to operate in accordance with the pseudocode 300.

The pseudocode 300 starts when the RAID array 120 is powered up (FIG. 3, line 4). The pseudocode 300 includes a variable “DRIVECOUNT” that sets the number of drives 121 in the RAID array 120 (FIG. 3, line 1), and a variable “CountDown” that sets the readiness period for waiting for the drives 121 to be ready (FIG. 3, line 7). The readiness period (e.g., 31 seconds) may be based on performance specifications of the drives 121. The pseudocode 300 checks for presence of the drives 121 (FIG. 3, line 8). The pseudocode 300 disables the connection between the RAID controller 103 and the drive expander 110 (FIG. 3, line 13), and starts the readiness period (FIG. 3, line 14). While the RAID controller-to-drive expander connection is disabled and the readiness period has not expired, the pseudocode 300 checks the readiness of all the drives 121 that have been found to be present (FIG. 3, lines 15-29), i.e., connected to corresponding connectors 122 (FIG. 3, line 8). The pseudocode 300 enables the RAID controller-to-drive expander connection when all of the drives 121 that have been found to be present are ready (FIG. 3, line 30).

While specific embodiments of the present invention have been provided, it is to be understood that these embodiments are for illustration purposes and not limiting. Many additional embodiments will be apparent to persons of ordinary skill in the art reading this disclosure.

What is claimed is:

1. A method of initializing a Redundant Array of Independent Disks (RAID) array during startup of a computer system, the method comprising:
disabling a connection between a RAID controller and a drive expander, wherein the RAID array is connected to the RAID controller through the drive expander;
checking for presence of member drives of the RAID array;
checking readiness of the member drives;
enabling the connection between the RAID controller and the drive expander when the member drives are ready; and
verifying integrity of a configuration of the RAID array after enabling the connection between the RAID controller and the drive expander.

2. The method of claim 1, wherein verifying the integrity of the configuration of the RAID array includes scanning a topology of the RAID array.

3. The method of claim 1, wherein disabling the connection between the RAID controller and the drive expander comprises:
disabling a serializer/deserializer (SerDes) physical layer (PHY) connection between the RAID controller and the drive expander.

4. The method of claim 3, wherein enabling the connection between the RAID controller and the drive expander comprises:
enabling the SerDes PHY connection between the RAID controller and the drive expander.

5. The method of claim 1, wherein the connection between the RAID controller and the drive expander is in accordance with Peripheral Component Interconnect Express (PCIe), serial attached Small Computer System Interface (SAS) interface, or Serial Advanced Technology Attachment (SATA) standard.

6. The method of claim 1, wherein checking for the presence of the member drives of the RAID array comprises:
checking a state of a presence pin of a connector of each of the member drives.

7. A computer system comprising:
a Redundant Array of Independent Disks (RAID) controller;
a RAID array; and
a drive expander that connects the RAID controller to the RAID array, the drive expander comprising at least one processor that executes instructions to cause the drive expander to:
disable a connection between the RAID controller and the drive expander during startup of the computer system;
check for presence of member drives of the RAID array;
check readiness of the member drives; and
enable the connection between the RAID controller and the drive expander after checking the readiness of the member drives.

8. The computer system of claim 7, wherein the drive expander checks for the presence of the member drives by checking a state of a presence pin of a connector of each of the member drives.

9. The computer system of claim 7, wherein the drive expander disables the connection between the RAID controller and the drive expander during the startup of the computer system by disabling a serializer/deserializer (SerDes) physical layer (PHY) connection between the RAID controller and the drive expander.

10. The computer system of claim 9, wherein the drive expander enables the connection between the RAID controller and the drive expander by enabling the SerDes PHY connection between the RAID controller and the drive expander.

11. The computer system of claim 7, wherein the connection between the RAID controller and the drive expander is in accordance with Peripheral Component Interconnect Express (PCIe), serial attached Small Computer System Interface (SAS) interface, or Serial Advanced Technology Attachment (SATA) standard.

12. The computer system of claim 7, wherein the computer system is a server computer system.

13. The computer system of claim 12, wherein the server computer system includes a motherboard, and the RAID controller is embodied in a card that is inserted into a bus slot of the motherboard.

14. The computer system of claim 13, wherein the bus slot is a Peripheral Component Interconnect Express (PCIe) bus slot.

15. A method of initializing a Redundant Array of Independent Disks (RAID) array during startup of a computer system, the method comprising:
disabling a connection between a RAID controller and a RAID array;
while the connection between the RAID controller and the RAID array is disabled, checking for presence of member drives of the RAID array and checking readiness of the member drives;
after checking the readiness of the member drives, enabling the connection between the RAID controller and the RAID array; and
after enabling the connection between the RAID controller and the RAID array, verifying integrity of a configuration of the RAID array.

16. The method of claim 15, wherein verifying the integrity of the configuration of the RAID array includes scanning a topology of the RAID array.

17. The method of claim 15, wherein disabling the connection between the RAID controller and the RAID array comprises:
disabling a serializer/deserializer (SerDes) physical layer (PHY) connection between the RAID controller and a drive expander, wherein the RAID array is connected to the RAID controller through the drive expander.

18. The method of claim 17, wherein enabling the connection between the RAID controller and the RAID array comprises:
enabling the SerDes PHY connection between the RAID controller and the drive expander.
